(19) United States
(12) Patent Application Publication
(10) Pub. No.: US 2005/0141944 A1
(43) Pub. Date: Jun. 30, 2005

(54) Image forming device to adjust paper feeding speed and method thereof

(76) Inventors: Sung-myun Lee, Anyang-si (KR); Young-soo Han, Suwon-si (KR)

Correspondence Address: STANZIONE & KIM, LLP, 1740 N STREET, N.W., FIRST FLOOR, WASHINGTON, DC, 20036, US

(21) Appl. No.: 11/014,881

(22) Filed: Dec. 20, 2004

(30) Foreign Application Priority Data
Dec. 24, 2003 (KR) 2003-96785

(51) Int. Cl. B41J 11/42

(52) U.S. Cl. 400/582

(57) ABSTRACT

An image forming device adjusts a paper feeding speed according to a type of a fed paper. The image forming device includes an interface part to receive and transmit data from and to a user terminal, a storage part to store print data transmitted via the interface part from the user terminal, a feeding control part to control a feeding mechanism to feed a sheet of paper to print the print data according to a predetermined feeding speed depending on a type of the fed paper, and a print part to print the print data on the fed paper. Accordingly, a paper can be fed according to the paper feeding speed selected or adjusted by a user, and can be printed such that a paper jam is prevented with respect to various kinds of papers, and therefore, both printing speed and quality can be improved.

### CROSS-REFERENCE TO RELATED APPLICATIONS

This application claims the benefit of Korean Patent Application No. 2003-96785 filed on Dec. 24, 2003, in the Korean Intellectual Property Office, the disclosure of which is incorporated herein by reference.

### BACKGROUND OF THE INVENTION

1. Field of the Invention

The present general inventive concept relates to an image forming device capable of adjusting a paper feeding speed, and a method thereof. More particularly, the present general inventive concept relates to an image forming device capable of adjusting a paper feeding speed in accordance with a paper in use, and a method thereof.

2. Description of the Related Art

Generally, an image forming device, such as a printer, has a feeding cassette in a main body, which holds a stack of papers. -If print data is transmitted from a user terminal, such as a personal computer PC, the image forming device feeds the papers from the feeding cassette to print the transmitted print data.

The papers of the feeding cassette are picked up sheet by sheet, and the picked-up paper passes along a certain path and moves to a prepared feeding position according to a rotation of a feeding roller. The paper located in the feeding position is moved at proper time and feeding speed by the feeding roller such that an image corresponding to the print data is printed on the paper.

Generally, the feeding roller revolves according to a print command under the control of a control part of the image forming device, thereby feeding the paper from the feeding position. In order to locate the paper in a desirable position to precisely print the image thereon, the paper has to be moved at a precise time and with a precise timing in accordance with a theoretical value, and the feeding speed of the paper has to be adjusted such that a next paper is precisely fed after finishing printing.

Since an error exists between an actual distance of a paper transposition by the feeding roller and a theoretical value due to vairables of the paper, such as a thickness, a quality, and a standard, the paper printing speed varies. Due to the varying paper feeding speed, problems and inconveniences occur. For example, a new paper sheet may be fed prior to printing the image on a previously-fed paper, which generally causes problems such as a paper jam or a double paper sheet feeding.

For a general image forming device, a feeding system employs a feeding error correction device having a complex mechanism for precise feeding. However, the feeding system has a difficulty in precisely adaptably adjusting a feeding speed according to a variety of paper. The papers vary depending on various factors, such as a manufacturer and a material, and the papers may vary even among provinces in one country. As such, calculating a proper paper feeding speed for the respective paper types of diverse countries by experiments, and applying the calculated paper feeding speed to the feeding system may cause both time and cost problems in developing and manufacturing the feeding system.

As user needs are getting more diverse, papers having various thickness and quality are used. Therefore, developing a feeding system operating with an adjustable paper feeding speed according to various paper types in hardware level has some limitations especially in the developing and manufacturing costs.

### SUMMARY OF THE INVENTION

The present general inventive concept provides an image forming device capable of adjusting a feeding speed of a sheet of paper to be printed in accordance with a user selection, and a method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an image forming device to adjust a feeding speed of a sheet of paper, the image forming device comprising an interface part to receive and transmit data from and to a user terminal, a storage part to store print data transmitted via the interface part from the user terminal, a feeding control part to control a feeding mechanism to feed the paper to print the print data in accordance with a predetermined paper feeding speed depending on a type of the fed paper; and a print part to print the print data on the fed paper.

The image forming device may further comprise a selection screen provision part to provide the user terminal with a selection screen to select the paper feeding speed. The selection screen provision part checks the selected paper feeding speed which is selected through the selection screed, and provides the feeding control part with the selected paper feeding speed.

The image forming device may further comprise a paper jam detection part to detect a paper jam during paper feeding. The feeding control part may determine if the paper feeding speed is selected by a user, and may adjust the paper feeding speed by applying a predetermined weight according to a paper jam rate detected at the paper jam detection part, if the paper feeding speed is not selected by the user.

The foregoing and/or other aspects and advantages of the present general inventive concept may be achieved by providing a method of adjusting a feeding speed of paper in an image forming device, the method comprising storing print data transmitted from a user terminal, feeding a sheet of paper according to a predetermined paper feeding speed of the paper depending on a type of the fed paper, and printing the print data on the fed paper.

The method may further comprise providing the user terminal with a selection screen to select the paper feeding speed. The feeding of the paper comprises checking the paper feeding speed selected through the selection screen to feed the paper according to the selected paper feeding speed.

The method may further comprise determining if the paper feeding speed is selected by a user, and adjusting the paper feeding speed a rate of a paper jam occurring during paper feeding.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming device capable of adjusting a paper feeding speed according to an embodiment of the present general inventive concept,

FIG. 2 is a view illustrating an example of a selection screen provided to a user terminal to adjust the paper feeding speed in the image forming device of FIG. 1; and

FIG. 3 is a flow chart illustrating a method of an image forming device capable of adjusting a paper feeding speed according to another embodiment of the present inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

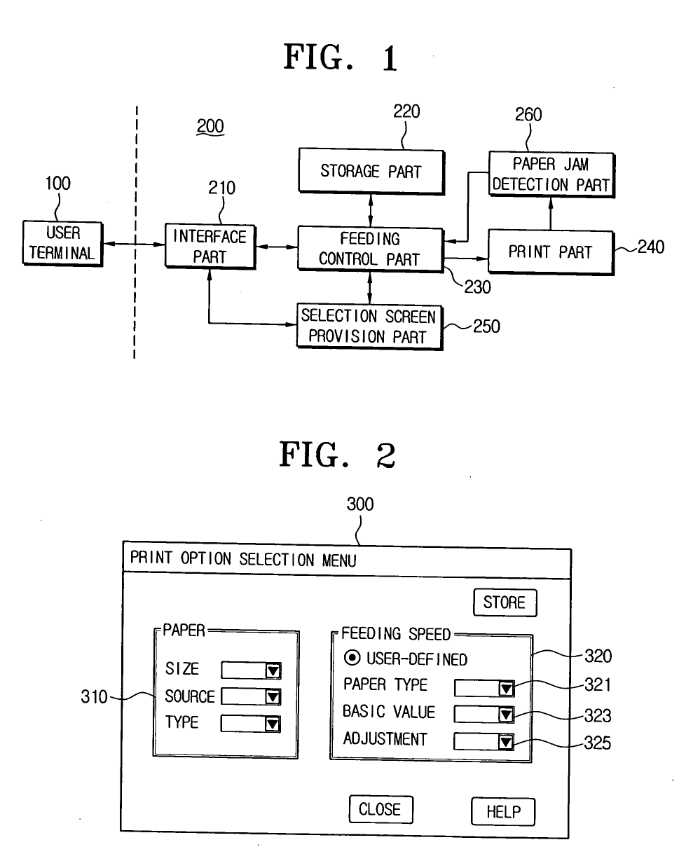

FIG. 1 is a block diagram illustrating an image forming device 200 to adjust a paper feeding speed according to an embodiment of the present general inventive concept. The image forming device 200 comprises an interface part 210, a storage part 220, a feeding control part 230, a print part 240 and a selection screen provision part 250. The image forming device 200 is connected via the interface part 210 to a user terminal 100 which is a user interface UI.

The image forming device 200 transmits data via the interface part 210 to the user terminal 10, and receives print data transmitted from the user terminal 100. The user terminal 100 is mainly provided with an inputting device, such as a PC, a display device, a memory device, an I/O interface part and a control part. A printer driver is built in the memory device and connected to the image forming device 200.

The storage part 220 stores the print data transmitted via the interface part 210 from the user terminal 100. The storage part 220 stores diverse data generated during performing various control programs to realize a function of the image forming device 200 and also stores data generated during an operation of the image forming device 200.

The feeding control part 230 adjusts a paper feeding interval between a sheet of paper and a next sheet of paper according to characteristics of paper, such as a standard, a thickness and a quality. The feeding control part 230 generates a control signal to control a drive part (not shown) to drive a feeding roller (not shown) so that the paper is timely precisely fed to be printed.

More specifically, the feeding control part 230 generates the control signal to control the feeding roller to transfer the sheets of paper, which are picked up from a feeding cassette and moved along a predetermined path to a feeding position, at a proper time, such that the sheet and next sheet of paper can be consecutively fed according to an appropriate (proper) time interval.

The feeding control part 230 can use a rate of a paper jam in determining the proper time interval to timely precisely feed the paper. The image forming device 200 comprises a paper jam detection part 250 to detect the paper jam.

The feeding control part 230 extends (adjusts) the paper feeding interval such that the next paper can be fed at a delayed time according to the paper jam rate detected in the paper jam detection part 250. The extended (adjusted) paper feeding interval may be adjusted by applying a certain weight, obtained by experiments according to the paper jam rate, to the paper feeding interval.

For example, the feeding control part 230 can extend the paper feeding interval as much as a weight according to the paper jam rate. As mentioned above, the weight may be obtained by experiments. However, if the weight obtained for only a few kinds of paper through the experiments is used, it may have a limitation to prevent the paper jam according to various kinds or types of papers.

Therefore, the image forming device 200 can adjust the paper feeding speed by a user's selection. For this, the image forming device 200 comprises a selection screen provision part 250.

The selection screen provision part 250 provides the user terminal 100 with a selection screen via the interface part 210 such that a user can select the paper feeding speed. The selection screen is provided by the selection screen provision part 250 and displayed on a display part (not shown) of the user terminal 100 which operates as the user interface UI.

The selection screen may provide a selection menu on a screen to select the paper feeding speed, and print commands and print options are input through the screen. The selection screen may also provide another menu on the screen to adjust the paper feeding speed, and printer registration information is shown in the menu of the screen when selecting a printer option. The selection screen to adjust a paper feeding time interval or the paper feeding speed can be shown if the corresponding menu is selected from the selection menu.

The selection screen provision part 250 can show on a user terminal the selection screen to select the paper feeding speed with various methods according to the user interface of the user terminal 100, in addition to selecting the menu to adjust the paper feeding speed in the printer driver.

A user can appropriately adjust the paper feeding speed in the selection screen provided from the selection screen provision part 250 when the paper jam occurs, and the selection screen provision part 250 stores the paper feeding speed selected according to the characteristic of the paper and provides with the stored paper feeding speed when a next selection screen is provided such that the user can adjust the feeding speed based on a previously selected paper feeding speed.

The selection screen provision part 250 provides the feeding control part 230 with the paper feeding speed selected by the user through the selection screen. The feeding control part 230 controls the feeding roller according to the paper feeding speed selected by the user and adjusted through the corresponding menu.

The print part 240 prints the print data transmitted from the user terminal 100. If the feeding control part 230 forms a print screen including plural pages selected by the user from the selection screen of the user terminal 100, the print part 240 prints the print data stored in the storage part 220 in accordance with formed print screen.

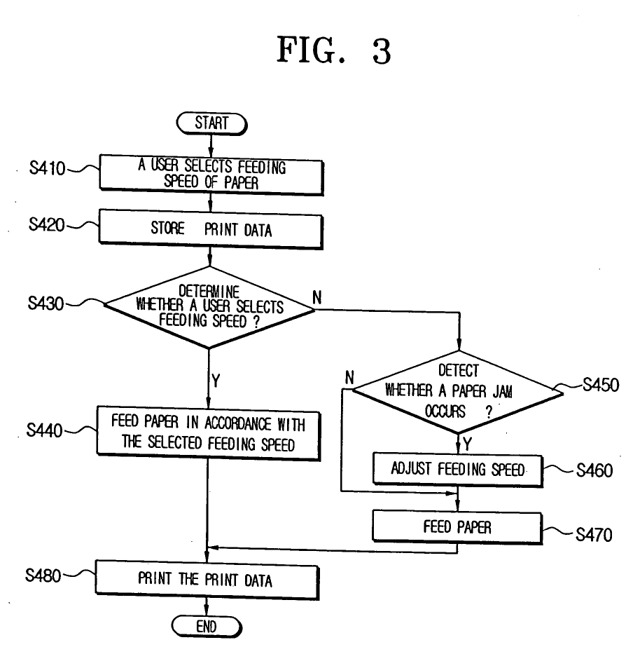

FIG. 2 is a view illustrating an example of a selection screen 300 provided in the user terminal 100 by the image forming device 200 of FIG. 1.

Referring to FIGS. 1 and 2, a paper size and sort selection item 310 is located on a left side of the selection screen 300 which is provided by the selection screen provision part 250, and a paper feeding speed selection item 320 is located on a right side of the selection screen 300.

The paper size and sort selection item 310 comprises a size selection item to select a size of paper, a source item to select a paper feeding method, and a sort item to select a quality of paper. A user can set each item as an automatic selection or a direct manual selection. When a user selects items, such as the size and sort of paper, the image forming device 200 prints according to a preset paper feeding speed corresponding to a combination of selection items of the selection screen 300.

If the paper feeding speed is selected only through the paper size and sort selection item 310, selection of sizes and sorts of paper may be limited, and therefore, the selection of the paper feeding speed may also be limited.

The selection items according to diverse thicknesses and qualities of papers may be limited, and paper feeding speed adjusting values to adjust the paper feeding speed according to the selection items may also be limited, if the paper feeding speed are obtained by experiments. An appropriate paper feeding speed according to various papers can be obtained and adjusted in the image forming device 200.

In a case of printing based on a fixed feeding speed, the paper jam may frequently occur. To overcome this, a user can directly select a paper feeding speed via the paper feeding speed selection item 320 as shown in FIG. 2. If the paper jam occurs, the paper feeding speed selection item 320 is used such that the user can directly select the paper feeding speed. A user-defined item is located on a top portion of the paper feeding speed selection item 320, and the user-defined item is checked if the user wants to select the paper feeding speed directly. The user can select the user-defined item to directly select the paper feeding speed.

A paper naming item 321 is to select a name (type) of the paper to be printed. The user can select the paper name among preset names or can define a new name to use.

If the user selects the paper name in the paper naming item 321, a basic value of the paper feeding speed corresponding to the selected paper name is indicated in a basic value item 323. If the basic value of the paper feeding speed corresponding to the selected paper name has been already selected, the selection screen provision part 250 keeps the basic value stored, and if the paper is selected, a pre-selected basic value is indicated in the basic value item 323.

The selection screen provision part 250 can indicate a preset basic feeding speed of the image forming device 200 according to basic information, such as a standard and quality of paper, as the basic value, if the paper name is newly defined by a user. Accordingly, if the paper jam occurs, the user can change the basic value based on the indicated basic value.

An adjustment item 325 is to minutely adjust the paper feeding speed based on the preset basic value. A user selects a value of the adjustment item 325 and can minutely adjust the paper feeding speed based on the basic value.

When the paper feeding speed is selected, the user stores the paper feeding speed and closes the selection screen 300. If the print command is input by a user, the selection screen provision part 250 checks the selection screen 300 to provide the feeding control part 230 with the selected paper feeding speed such that the feeding of the paper can be controlled in accordance with the selected paper feeding speed.

FIG. 3 is a flow chart illustrating a method of an image forming device capable of adjusting a paper feeding speed according to another embodiment of the present invention.

Referring to FIGS. 1 through 3, a user uses the selection screen 300 provided by the selection screen provision part 250 at the user terminal 100 to select or adjust the paper feeding speed of a sheet of paper (S410), and inputs a print command.

The storage part 220 stores the print data transmitted via the interface part 210 from the user terminal 100 (S420). The selection screen provision part 250 checks the selection screen 300 and determines whether a user selects the paper feeding speed (S430). If the user selects the paper feeding speed, the selection screen provision part 250 checks the selected paper feeding speed to transmit to the feeding control part 230.

The feeding control part 230 controls to feed a sheet of paper according to the selected paper feeding speed (S440), and prints the print data on the paper through the print part 240 (S480).

If the paper feeding speed is not selected by the user, the feeding control part 230 uses a value output from the paper jam detection part 260 to control the paper feeding speed.

The paper jam detection part 260 detects whether the paper jam occurs (S450). If the paper jam occurs, the paper jam detection part 260 detects the paper jam and informs the feeding control part 230 of the detected paper jam. The feeding control part 230 calculates the paper jam rate of each type (kind) of paper according to the paper jam detected from the paper jam detection part 260 so as to adjust the selected paper feeding speed based on the calculated paper jam rate (S460). For this, the feeding control part 230 or the paper jam detection part 260 may have a memory (not shown) to store the paper jam rate corresponding to the paper type. If the paper jam occurs, the feeding control part 230 adjusts the paper feeding speed according to the paper to control the feeding roller (not shown) to feed the paper (S470).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image forming device to adjust a feeding speed of paper, comprising:
an interface part to receive and transmit data from and to a user terminal;
a storage part to store print data transmitted via the interface part from the user terminal;
a feeding control part to feed a sheet of paper according to a paper feeding speed corresponding to a type of the paper; and
a print part to print the data on the fed paper.

2. The image forming device according to claim 1, further comprising:
a selection screen provision part to provide the user terminal with a selection screen to select the paper feeding speed.

3. The image forming device according to claim 2, wherein the selection screen provision part checks the selected paper feeding speed from the selection screen and provides the selected paper feeding speed to the feeding control part.

4. The image forming device according to claim 1, further comprising:
a selection screen provision part to provide a selection screen to adjust the paper feeding speed.

5. The image forming device according to claim 4, wherein and the feeding control part feeds the paper according to the adjusted paper feeding speed.

6. The image forming device according to claim 1, further comprising:
a paper jam detection part to detect a paper jam during paper feeding.

7. The image forming device according to claim 6, wherein the feeding control part determines if the paper feeding speed is selected, and adjusts the paper feeding speed by applying a predetermined weight corresponding to a paper jam detected at the paper jam detection part to adjust the paper feeding speed, and the feeding control part feeds the paper according to the adjusted paper feeding speed.

8. An image forming device, comprising:
a storage part to store print data;
a feeding control part to feed a sheet of paper according to a paper feeding speed corresponding to a type of the paper; and
a print part to print the print data on the fed paper.

9. The image forming device according to claim 8, further comprising:
a selection screen provision part to provide a selection screen having a paper size and sort selection item section and a paper feeding speed selection item section to select paper feeding speed corresponding to the type of the paper.

10. The image forming device according to claim 9, wherein the paper size and sort selection item section comprises at least one of a size selection item to select a size of the paper, a source item to select a paper feeding method, and a sort item to select a quality of paper, so that the paper feeding speed is selected from one or more combinations of the size, paper feeding method, and a quality of the paper, and the feeding control part feeds the paper according to the selected paper feeding speed.

11. The image forming device according to claim 9, wherein the paper feeding speed selection item section comprises at least one of a paper name item to select a name of the paper, a basic value item to select a basic value according to the paper name, and an adjustment item to adjust the paper feeding speed according to the basic value, and the feeding control part feeds the paper according to the adjusted paper feeding speed.

12. The image forming device according to claim 9, wherein the paper feeding speed is adjusted through the selection screen, and the feeding control part feeds the paper according to the adjusted paper feeding speed.

13. The image forming device according to claim 9, further comprising:
a paper jam detection part to detect a paper jam rate corresponding to the paper so that the paper feeding speed is adjusted according to the paper jam rate,
wherein the feeding control part feeds the paper according to the adjusted paper feeding speed.

14. The image forming device according to claim 8, further comprising:
a paper jam detection part to detect a paper jam rate corresponding to the paper so that the paper feeding speed is adjusted according to the paper jam rate,
wherein the feeding control part feeds the paper according to the adjusted paper feeding speed.

15. The image forming device according to claim 14, wherein the feeding control part applies a predetermined weight corresponding to the paper jam rate of the paper jam detection part, to the paper feeding speed, so that the paper feeding speed is adjusted, and the feeding control part feeds the paper according to the adjusted paper feeding speed.

16. The image forming device according to claim 8, further comprising:
a paper jam detection part to adjust a paper jam rate corresponding to the paper when a paper jam occurs during feeding the paper, so that the paper feeding speed is adjusted according to the adjusted paper jam rate,
wherein the feeding control part feeds the paper according to the adjusted paper feeding speed.

17. The image forming device according to claim 16, wherein the feeding control part applies a predetermined weight corresponding to the paper jam rate of the paper jam detection part, to the paper feeding speed, so that the paper feeding speed is adjusted, and the feeding control part feeds the paper according to the adjusted paper feeding speed.

18. The image forming device according to claim 8, wherein the feeding control part feeds a next sheet of paper a delayed time after feeding the sheet of paper, according to a paper feeding interval corresponding to the paper feeding speed.

19. The image forming device according to claim 18, wherein the paper feeding interval corresponding to the sheet of paper and the next sheet of paper is adjusted according to the type of paper, and the feeding control part feeds the sheet of paper and the next sheet of paper according to the adjusted paper feeding interval.

20. A method of an image forming device, the method comprising:
storing print data transmitted from a user terminal;
feeding a sheet of paper according to a paper feeding speed corresponding to a type of the paper; and
printing the print data on the fed paper.

21. The method according to claim 20, further comprising:
providing the user terminal with a selection screen to select the paper feeding speed.

22. The method according to claim 21, wherein the feeding of the paper comprises checking the selected paper feeding speed, and feeding the paper according to the selected paper feeding speed.

23. The method according to claim 20, further comprising:
determining if the paper feeding speed is selected;
adjusting the paper feeding speed according to a paper jam rate occurring during paper feeding; and
feeding the paper according to the adjusted paper feeding speed.

24. The method according to claim 20, further comprising:
feeding a next sheet of paper a delayed time after feeding the sheet of paper, according to a paper feeding interval corresponding to the paper feeding speed.

25. The method according to claim 24, wherein the feeding of the next sheet of paper comprises:
adjusting the paper feeding interval corresponding to the sheet of paper and the next sheet of paper; and
feeding the sheet of paper and the next sheet of paper according to the adjusted paper feeding interval.
